(19) United States
(12) Patent Application Publication
(10) Pub. No.: US 2023/0206616 A1
(43) Pub. Date: Jun. 29, 2023

(54) WEAKLY SUPERVISED OBJECT LOCALIZATION METHOD AND SYSTEM FOR IMPLEMENTING THE SAME

(71) Applicant: NEC CORPORATION, Tokyo (JP)

(72) Inventors: Vivek BARSOPIA, Tokyo (JP); Hiroshi TAMANO, Tokyo (JP); Yoshio KAMEDA, Tokyo (JP)

(21) Appl. No.: 17/927,739

(22) PCT Filed: Oct. 5, 2020
(86) PCT No.: PCT/JP2020/037728

§ 371 Date: Nov. 25, 2022

(30) Foreign Application Priority Data
Jun. 12, 2020 (US) 63038181

(51) Int. Cl. G06V 10/82; G06V 10/764; G06V 10/77

(52) U.S. Cl. CPC G06V 10/82; G06V 10/764; G06V 10/7715

(57) ABSTRACT

A method of training an image recognition model includes masking a first region of a first image with a first portion of a second image to define a mixed image, wherein the first image is different from the second image, and a location of the first region in the first image corresponds to a location of the first portion in the second image. The method further includes performing masked global average pooling (GAP) on both the mixed image. The method further includes generating a first classification score for the first image and a second classification score for the second image based on the masked GAP of the mixed image.

### TECHNICAL FIELD

The present invention relates to a weakly supervised object localization method and a system for implementing the same.

### BACKGROUND ART

Image recognition models analyze groups of pixels of images in order to predict the content of an image. In some instances, the pixels analyzed by the image recognition model are not related to a primary subject of the image. As a result, the model returns an inaccurate prediction in a higher number of instances. In some instances, the pixels analyzed by the image recognition model focus heavily on only a portion of the object instead of whole object in the image. As a result, the model fails to accurately predict the content of the image in a higher number of instances.

Efforts to train image recognition models to consider more pixels associated with the primary subject of the image include hiding portions of a training image in order to train the model to consider different sets of pixels for analyzing feature of the image. In some instances, bounding boxes used to analyze groups of pixels overlap both the image to be analyzed and a hidden portion of the image. As a result, the training of the image recognition model is trained using irrelevant pixels which increases a risk of error in the prediction.

### SUMMARY OF INVENTION

According to an example aspect of the present invention, a method of training an image recognition model is a method including: masking a first region of a first image with a first portion of a second image to define a mixed image, wherein the first image is different from the second image, and a location of the first region in the first image corresponds to a location of the first portion in the second image; performing masked global average pooling (GAP) on both the mixed image; and generating a first classification score for the first image and a second classification score for the second image based on the masked GAP of the mixed image.

According to an example aspect of the present invention, an age recognition system includes: a non-transitory computer readable medium configured to store instructions thereon; and a processor connected to the non-transitory computer readable medium, wherein the process is configured to execute the instructions for: masking a first region of a first image with a first portion of a second image to define a mixed image, wherein the first image is different from the second image, and a location of the first region in the first image corresponds to a location of the first portion in the second image; performing masked global average pooling (GAP) on both the Winced image; and generating a first classification score for the first image and a second classification score for the second image based on the masked GAP of the mixed image.

According to an example aspect of the present invention, a program includes instructions, which when executed by a processor cause the processor to: mask a first region of a first image with a first portion of a second image to define a mixed image, wherein the first image is different from the second image, and a location of the first region in the first image corresponds to a location of the first portion in the second image; perform masked global average pooling (GAP) on both the mixed image and the inverted mixed image; and generate a first classification score for the first image and a second classification score for the second image based on the masked GAP of the mixed image.

### BRIEF DESCRIPTION OF DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a flowchart of a method of training an image recognition model in accordance with some example embodiments.

FIG. 2 is a diagram of an image recognition system for training an image recognition model in accordance with some example embodiments.

FIG. 3 is a schematic diagram of a masked GAP process in accordance with some example embodiments.

FIG. 4A is a view of image(s) and mask(s) in accordance with some example embodiments.

FIG. 4B is a view of image(s) and mask(s) in accordance with some example embodiments.

FIG. 4C is a view of image(s) and mask(s) in accordance with some example embodiments.

FIG. 4D is a view of image(s) and mask(s) in accordance with some example embodiments.

FIG. 4E is a view of image(s) and mask(s) in accordance with some example embodiments.

FIG. 4F is a view of image(s) and mask(s) in accordance with some example embodiments.

FIG. 5 is a flowchart of a method of testing an image recognition model in accordance with some example embodiments.

FIG. 6 is a diagram of an image recognition system in accordance with some example embodiments.

FIG. 7 is a diagram of a system for implementing an image recognition method in accordance with some example embodiments.

### DESCRIPTION OF EXAMPLE EMBODIMENTS

The following disclosure provides many different example embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows may include example embodiments in which the first and second features are formed in direct contact, and may also include example embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various example embodiments and/or configurations discussed.

Training of image recognition models is a time consuming process. Training the model to accurately recognize a primary subject of a training image helps to increase the reliability of the model during testing (actual use of the model).

Using masked global pooling average (GAP) helps to accurately train the model by mixing multiple training images for analysis by the image recognition system. information for the location and size of patches of the mixed images are provided to the image recognition system. The mixing of the images forces the model to consider multiple groups of pixels for recognizing the primary subject matter of the training image. By relying on multiple groups of pixels, the image recognition model is able to more accurately predict the primary subject of the image during the testing phase. By providing the size and location of the patches in the mixed image, bounding boxes that overlap a boundary of the patch are avoided. Bounding boxes define the group of pixels being analyzed by the image recognition model. By preventing the bounding box from overlapping with the boundary of the patch, the image recognition model is less likely to confuse features of the image in the patch with the image of the primary subject. As a result, the training of the image recognition model is improved to provide more accurate models for use in a testing phase.

In addition, mixing the training images permits parallel analysis of each of the mixed image. For example, a mixed image includes a first image having a patch of a second image in a lower right corner hiding portions of the first image. One of ordinary skill in the art would recognize that the above is merely an example and that additional patches and additional images are usable for forming mixed images and inverted mixed images. The parallel analysis enables training of the image recognition model for multiple images simultaneously. As a result, the time for producing a trained model usable for testing is reduced in comparison with other approaches.

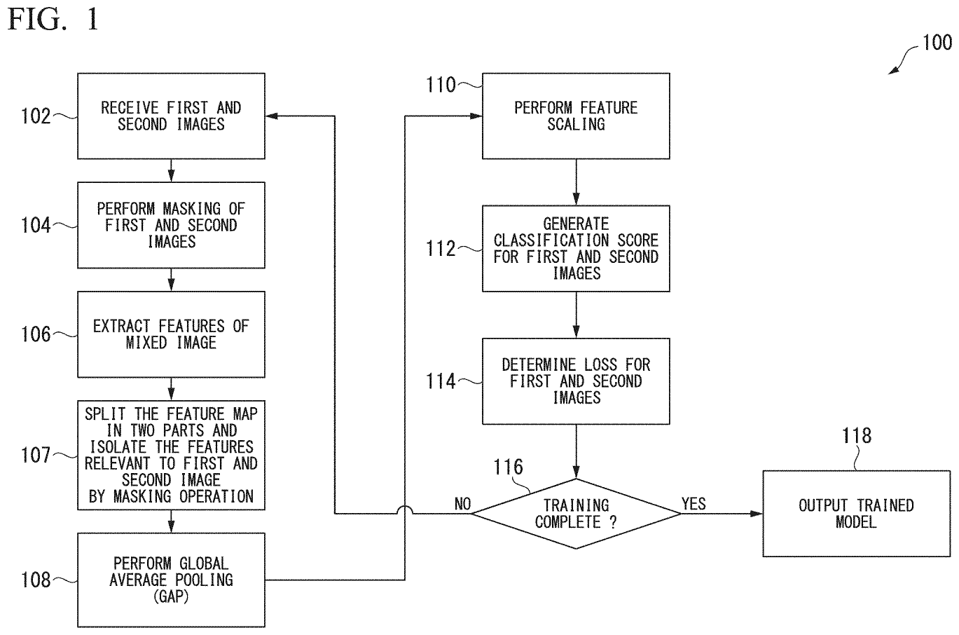

FIG. 1 is a flowchart of a method 100 of training an image recognition model in accordance with some example embodiments. The method 100 is usable to train an image recognition model In some example embodiments, the image recognition model is usable for retrieving information from a server. In some example embodiments, the image classification model is usable to identify the contents of an image. In some example embodiments, the image recognition model is usable in image analysis, such as medical image analysis.

In operation 102, a first image and a second image are received. The first image and the second image are training images. In some example embodiments, the first image and the second image are retrieved from a database. In some example embodiments, the first image and the second image are provided by a user. In some example embodiments, the first image and the second image are received from a same external device. In some example embodiments, the first image and the second image are received from different external devices. In some example embodiments, a size of the first image is 224 pixels by 224 pixels. In some example embodiments, the size of the first image is greater than or less than 224 pixels by 224 pixels. In some example embodiments, a shape of the first image is polygonal, circular, free form, cow spots or another suitable shape. In some example embodiments, the first image is rectangular.

In some example embodiments, a size of the second image is 224 pixels by 224 pixels. In some example embodiments, the size of the second image is greater than or less than 224 pixels by 224 pixels. In some example embodiments, a shape of the second image is polygonal, circular, free form, cow spots or another suitable shape. In some example embodiments, the second image is rectangular. In some example embodiments, the second image has a different size or a different shape from the first image. In some example embodiments, the second image as a same size and shape as the first image.

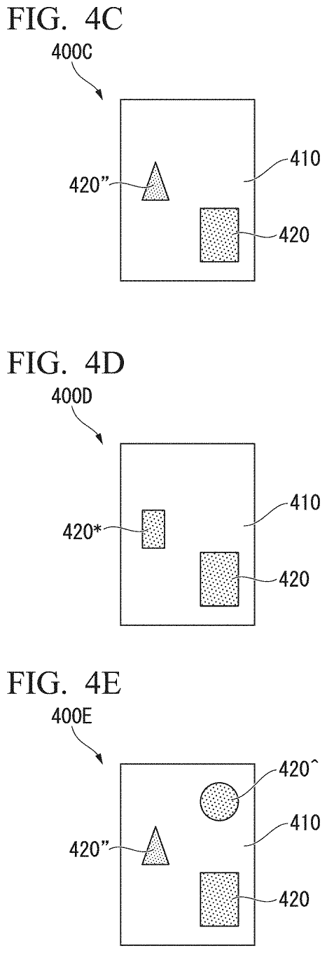

In operation 104, masking of the first and second images is performed. Masking the first and second images produces a mixed image. The mixed image is produced by overlaying a portion of the second image over a corresponding portion of the first image. The position of the masked portion is the same for each of the mixed image and the inverted mixed image. While the above example is described with respect to two images and a single masked portion, one of ordinary skill in the art would understand that method 100 is usable with more than two images and more than a single masked portions. Additional example embodiments of masked portions are described below with respect to FIGS. 4A-4F.

A ratio between a size of the masked portion and a size of the first image is call a feature scaling ratio. In some example embodiments, the feature scaling ratio ranges from about 0.2 to about 0.7. In some example embodiments, the feature scaling ratio is about 0.5. In some example embodiments, the feature scaling ratio is determined based on empirical testing. As more of the first image is covered by the masked portion the feature scaling ratio decreases. As a result, fewer features of the first image are available for extraction; and training of the image recognition model is prolonged. As a size of the feature scaling ratio decreases, an ability to control the location of the extracted features is reduced. As a result, a risk of the image recognition model making an inaccurate determination increases. The size or feature scaling ratio of the masked portion is stored for later use. In some example embodiments, the size of the masked portion is determined at random. In some example embodiments, the size of the masked portion is determined at random within predetermined bounds, e.g., to generate a feature scaling ratio between about 0.2 and about 0.7. In some example embodiments, the size of the masked portion is provided by the user.

The location of the masked portion is at a same position for each of the mixed image and the inverted mixed image. In some example embodiments, the location of the masked portion is determined by the user. In some example embodiments, the location of the masked portion is determined at random. In some example embodiments, the location of the masked portion is selected to overlay predetermined areas of the first image. In some example embodiments, the location of the masked portion is selected to overlay predetermined areas of the second image. Overlay predetermined areas with black or grey or random patch, i.e. a patch with no subject.

In some example embodiments where the size of the second image is different from the size of the first image, a size of the masked portion is adjusted proportionally to account for the size difference in the first and second images.

In operation 106, features of the mixed image obtained by combining first and second are extracted. In some example embodiments a convolution neural network (CNN) (like resnet, vgg, inception with truncated at some convolutional-relu pair) is used to generate the mixed feature maps. The feature map is formed by convoluting the filter with an input image, (in this case, mixed image), at different locations in the input image to generate a feature map. For example, for a dog, the CNN generates a feature map marking presence of tail or face or wheel like pattern in some example embodiments. One of ordinary skill in the art would recognize that the number of feature maps are not limited to three and can be any number.

In operation 107, the dropout and inverse dropout on mixed feature maps to generate two new feature maps, first feature map consisting of features where parts of first image in mixed image exists. And second feature map consisting of features where parts of second image in mixed image exits.

In operation 108, global average pooling (GAP) is performed. GAP is performed on the features maps of the mixed image. GAP converts each feature map into a single number by totaling the elements within the feature map and dividing the total by the number of elements, in the feature map. (i.e. average the pixel in feature map)

The GAP in operation 108 effectively excludes the masked portions of the mixed image, so the GAP is called a masked GAP.)

In 110, the feature scaling ratio for features relevant to first and second image are scaled. GAP(F)/λ, where λ is the feature scaling ratio. The feature scaling is performed for the inverted mixed image by dividing the results of the GAP by 1 minus the feature scaling ratio for the inverted mixed image, i.e., GARP′)/(1λ), where λ is the feature scaling ratio. The masked GAP produces a two feature vectors to representing subject in first and second image respectively.

The size and location of the masked portions for the mixed image and the inverted mixed image are used during the mask GAP to permit the GAP from avoiding consideration of the masked portions. By avoiding inclusion of the masked portions, the masked GAP is able to force the image recognition model to be trained for localized features within the first and second images. As a result, the image recognition model is more likely to produce accurate results during testing. Using masked GAP also helps to avoid issues associated with other approaches were a bounding box for identifying a feature of an image overlaps a hidden portion of the image. By providing the size and location of the masked portions, the mask GAP avoids such a problem with bounding boxes,

In some example embodiments, the GAP 224a, 224b is performed simultaneously for both the mixed images.

In operation 110, feature scaling is performed. Feature scaling helps to improve consistency of the feature vectors generated by the masked GAP. Feature scaling (226a, 226b) normalizes the feature vectors 228a, 228b obtained of the masked. GAJ which helps the image recognition model to converge faster (converge to better minima).

In operation 112, a classification score is generated for both the first and second images. The classification score for the first and the second image is generated based on the output from the feature scaling for first and second feature vector(f′). The classification scores are a determination of a class for each of the first and second images, i.e., there are two classification scores. The classes are the primary subject for the first image and the primary subject for the second image.

In some example embodiments, the classification score is generated using a fully connected layer. A fully connected layer is where each feature vector is connected to every class by a weight and a bias. The kth class score is determined by first taking a dot product between feature normalized vectors(f or f′) with the class weights wₖ and adding a bias bₖ. For each class the classification score is obtained.

A class having a highest score is determined to be the class of the corresponding image. For example, if the primary subject of the first image is a dog, the goal of the image recognition model is to return a class of “dog,”. In some example embodiments, the class for the first image is a same class as for the second image. In some example embodiments, the class for the first image is different from the class for the second image.

In operation 114, the loss is determined based on a comparison between the class of first and second images determined in operation 112 and the known primary subject of the first and second images. In some example embodiments, the loss is determined using cross entropy analysis, means square analysis, or another suitable loss function analysis.

In operation 116, a determination is made regarding whether the training of the image recognition model is complete. In response to a determination that the training is complete, i.e., “YES,” the method 100 proceeds to operation 118. In response to a determination that the training is not completed, i.e., “NO,” the method returns to operation 102 and another same process with two new image is performed.

In some example embodiments, the determination that training is complete is made based on the loss determined in operation 114 being below a predetermined loss threshold. That is, the accuracy of the image recognition model is deemed sufficient for use in the testing phase. In some example embodiments, the predetermined loss threshold is set by the user. In some example embodiments, the predetermined loss threshold is determined based on the designed use of the image recognition model. For example, if the image recognition model is designed for use for facial recognition, the predetermined loss threshold is higher than a predetermined loss threshold associated with a designed use for internet searching, in some example embodiments.

In some example embodiments, the determination that training is complete is made based on a number of epochs of training performed on the image recognition model. One execution of operations 102-114 of the method 100 for every train sample is train dataset is an epoch. In response to a determination that the number of epochs is equal to or greater than a predetermined epoch threshold the training is deemed to be complete. In some example embodiments, the predetermined epoch threshold is set by the user. In some example embodiments, the predetermined epoch threshold is determined based on the designed use for the image recognition model. In some example embodiments, the determination that the training is complete is made based on a combination of the number of epochs and the loss determined in operation 114.

In response to a determination that the training is not complete, the image recognition model is modified based on the loss determined in operation 114. The image recognition model is modified by adjusting weights and/or biases used in generating the classification scores in operation 112. In some example embodiments, the image recognition model is modified using back propagation techniques which adjusts the weights and/or biases.

In operation 118, the trained image recognition model is output. Outputting the image recognition model includes storing the weights and biases of the image recognition model. In some example embodiments, the trained image recognition model is stored on a memory. In some example embodiments, the trained image recognition model is output to an external device. In some example embodiments, the trained image recognition model is stored and access to the trained image recognition model is granted to an external device,

In some example embodiments, the trained image recognition model undergoes a re-training process, in which method 100 is performed again to help improve the performance of the image recognition model. In some example embodiments, the trained image recognition model undergoes re-training periodically. In some example embodiments, the period for re-training is yearly, monthly or another suitable time frame. In some example embodiments, the re-training is performed in response to a determination that the performance of the trained image recognition model is unacceptable. In some example embodiments, the determination that the performance is unacceptable is based on comments from users. In some example embodiments, the determination that the performance is unacceptable is based on a rate of inaccurate predictions during the testing phase exceeding a predetermined error threshold. In some example embodiments, the predetermined error threshold is set by the user. In some example embodiments, the predetermined error threshold is determined based on the designed use of the image recognition model.

By using the method 100, the image recognition model is trained faster and with a higher degree of accuracy in comparison with other approaches which do not include masked GAP. The use of the masked GAP helps to force the image recognition model consider all relevant features in images during the training phase resulting in better classification and localization performance of the image recognition model during the testing phase.

In some example embodiments, the method 100 includes additional operations. For example, in some example embodiments, the method 100 further includes a reporting or alerting operation for displaying results of the classification scores to the user. In sonic example embodiments, an order of operations in the method 100 is changed. For examples, in some example embodiments, operation 104 is performed by an external device and the masked images are sent to the image recognition model for training in operation 102 afterwards. In some example embodiments, at least one of the operations of the method 100 is omitted. For example, in some example embodiments, the operation 110 is omitted.

While the description of the method 100 is based on two images and a single masked portion, one of ordinary skill in the art would recognize that the method 100 is usable with more than two images and more than a single masked portion.

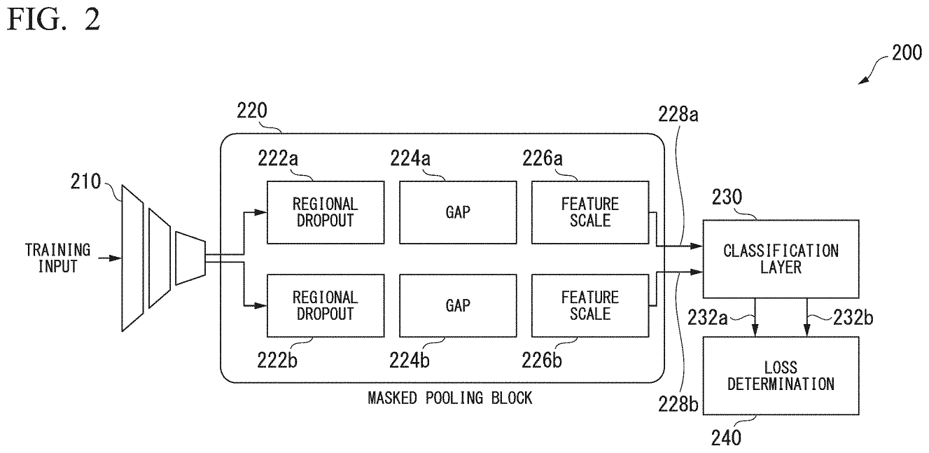

FIG. 2 is a diagram of an image recognition system 200 for training an image recognition model in accordance with some example embodiments. In some example embodiments, the image recognition system 200 is used for implementing method 100. In some example embodiments, the image recognition system 200 is used for implementing other training methods.

The image recognition system 200 includes a backbone network 210 for receiving a training input. In some example embodiments, the training input is a mixed image. In some example embodiments, the training input is a first image or second image (when lambda is 1 or 0). The backbone network 210 generates feature maps based on the received training input. In some example embodiments, the backbone network 210 generates the feature maps using operation 106 of the method 100. In some example embodiments, the backbone network 210 generates the feature maps using another method.

The image recognition system 200 further includes a masked pooling block 220. The masked pooling block 220 is configured to perform a masked GAP process and feature scaling on the feature maps generated by the backbone network 210. The masked pooling block 220 includes two parallel analysis tracks. The number of analysis tracks in the masked pooling block 220 is based on the number of images used to form the training input. While the description of the masked pooling block 220 is based on two images being used to form the training input, one of ordinary skill in the art would recognize that the masked pooling block 220 is capable of having snore than two analysis tracks as the number of images used to form the training input increases. The analysis track including activities 222a, 224a and 226a is used to analyze the features related to first image in mixed image, and is called the first image track. The analysis track including activities 222b, 224b and 226b is used to analyze the features related to second image in mixed image, and is call the second image track. That is, for example, activities are performed in the order of 222a, 222b, 224a, 224b, 226a and 226b.

The masked pooling block 220 is configured to perform regional dropout 222a in which the masked pooling block 220 receives information related to the masked portion of the first image. In some example embodiments, the masked pooling block 220 is configured to receive the information related to the masked portion of the first image from an external device. In some example embodiments, the masked pooling block 220 is configured to retrieve the information related to the masked portion of the first image from a memory. In some example embodiments, the information related to the first image includes a number of masked portions, a shape of each masked portion, a location of each masked portion, or other relevant information related to the masked portion of the first image. In sonic example embodiments, the mixed image is defined as a sum of a masked portion of the first image and an inverted mask applied to the second image.

The masked pooling block 220 is configured to perform GAP 224a in which the masked pooling block 220 performs GAP on the mixed image based on the masked feature map 330a received from the regional dropout 222a. In some example embodiments, the GAP 224a is performed using operation 108 of the method 100. The size and location of the masked portions for the first and second image are used during the masked pooling block 220 to avoid consideration of the masked portions. By avoiding inclusion of the masked portions, the masked GAP is able to force the image recognition model to be trained to extract features related to first image in feature map locations where first image is not masked. As a result, the image recognition model is more likely to produce accurate results during testing. Using masked GAP also helps to avoid issues associated with other approaches were a bounding box for identifying a subject (related to first image) in mixed image overlaps a hidden portion of the first image. By providing the size and location of the masked portions, the masked pooling block 220 avoids such a problem with bounding boxes. The masked pooling block 220 produces feature vector 228a corresponding to first image and feature vector 228b corresponding to second image.

The masked pooling block 220 is configured to perform feature scaling 226a.

The feature scaling 226a helps to improve the consistency of the feature becoming inconsistent due to regional dropout 222a. In sonic example embodiments, the feature scaling 226a is performed by executing the operation 110 of the method 100.

The masked pooling block 220 is configured to perform regional dropout 222b in which the masked pooling block 220 receives information (M′ or m′) related to the masked portion of the second image. The performance of the regional dropout 222b is similar to the performance of the regional drop out 222a, so detailed description of the regional dropout 222b is omitted for the sake of brevity.

The masked pooling block 220 is configured to perform GAP 224b in which the masked pooling block 220 performs GAP on the mixed feature maps based on the information received from the regional dropout 222b. The performance of the GAP 224b is similar to the performance of the GAP 224a, so detailed description of the GAP 224b is omitted for the sake of brevity.

The masked pooling block 220 is configured to perform feature scaling 226b to help improve the consistency of the feature vector generated by the masked GAP 224b. The performance of the feature scaling 2261 is similar to the performance of the feature scaling 226a, so detailed description of the feature scaling 226b is omitted for the sake of brevity.

The image recognition system 200 includes a classification layer 230 for generating class scores. The classification layer is configured to receive features vector 228a from the mixed image track and feature vector 228b from the inverted image track.

The classification layer 230 includes a fully connected layer for predicting an outcome based on the received features vector 228a and feature vector 228b. The class is determined based on a weight and a bias for a connection between each of the feature vector normalized by the feature scaling and the class. A class having a highest score is determined to be the class of the corresponding image. In some example embodiments, the classification layer 230 executes the operation 112 of the method 100. The classification layer 230 is configured to output a first image classification score 232a based on the feature vectors 228a. The classification layer 230 is configured to output a second image classification score 232b based on the feature vector 228b. In some example embodiments, the classification layer 230 is configured to generate the first image classification score 232a and the second image classification score 232b simultaneously. In some example embodiments, the classification layer 230 is configured to generate the first image classification score 232a and the second image classification score 232b in an independent manner.

The image recognition system 200 further includes a loss determination unit 240. The loss determination unit 240 is configured to determine the loss for both the first image classification score 232a and the second image classification score 232b. In some example embodiments, the loss determination unit is configured to determine the loss using cross entropy analysis, means square analysis, or another suitable loss function analysis. In some example embodiments, the loss determination unit 240 is configured to execute the operation 114 of the method 100.

The image recognition system 200 is configured to punish the image recognition model in response to the losses determined by the loss determination unit 240 exceeding a predetermined loss threshold. The predetermined loss threshold is discussed above, so detailed discussion is omitted for brevity. The image recognition model adjusts weights and/or biases used in the classification layer 230 and may also adjust weight in backbone network. In some example embodiments, back propagation technique is used to adjust the weights and/or biases of the image recognition model in order to lower loss.

The image recognition system 200 is configured to output the trained image recognition model includes the weights and biases of the trained image recognition model. In some example embodiments, the trained image recognition model is stored on a memory. In some example embodiments, the trained image recognition model is output to an external device. In some example embodiments, the trained image recognition model is stored and access to the trained image recognition model is granted to an external device.

In some example embodiments, the image recognition system 200 is configured to re-train the trained image recognition model. Details for re-training are discussed above, so detailed discussion of the re-training is omitted for the sake of brevity.

By using the image recognition system 200, the image recognition model is trained faster and with a higher degree of localization accuracy in comparison with other approaches which do not include masked pooling block. The use of the masked pooling block helps to force the image recognition model consider all maximum features in images while avoiding irrelevant ones during the training phase resulting in better performance of the image recognition model during the testing phase.

In some example embodiments, the image recognition system 200 includes a memory for storing instructions and at least one processor for executing the instructions. The at least one processor is configured to execute the instructions for implementing the backbone network 210, the masked pooling block 220, the classification layer 230 and the loss determination unit 240.

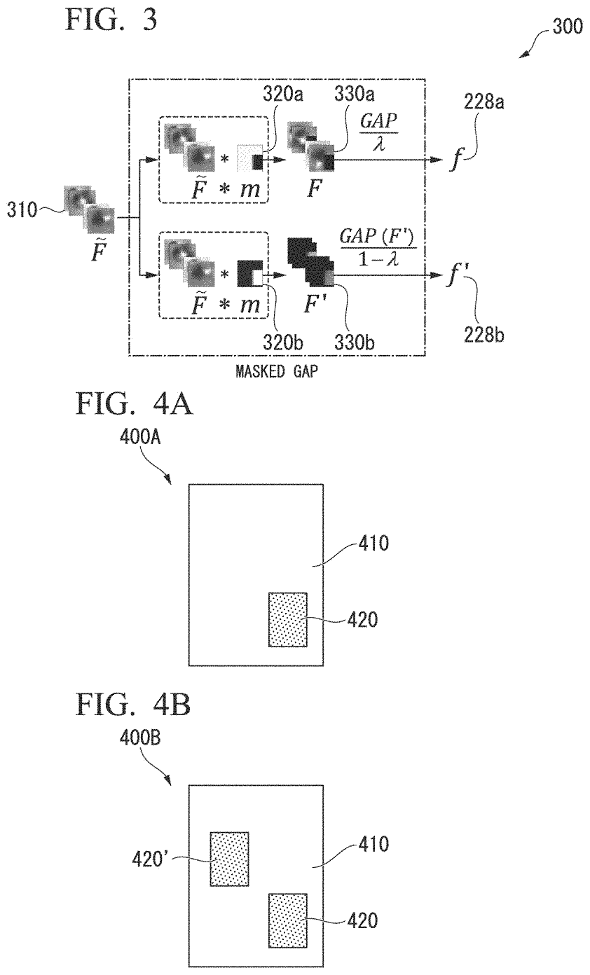

FIG. 3 is a schematic diagram of masked GAP (a masked pooling block) process 300 in accordance with some example embodiments. FIG. 3 is a visual representation of forming a feature vector 228a, 228b by masked GAP (a masked pooling block) process 300 on the mixed feature map 310 obtained by passing mixed image through backbone network 210. The process 300 includes the use of two images and a single masked portion. The process 300 includes two tracks, one for each image. One of ordinary skill in the art would understand that the process 300 is usable with more than two images and more than a single masked portion. In some example embodiments, the output of process 300 is feature vectors similar to the operation 108 in the method 100.

The process 300 receives feature maps 310. The feature maps 310 are feature maps for a input image. In some example embodiments, the feature maps 310 are received from a backbone network, e.g., backbone network 210. In some example embodiments, the feature maps 310 are received from an external device.

In a first image track, the feature maps 310 are combined with masked portion information 320a. The dark portion of masked portion information 320a indicates the portion of the feature maps 310 to be replaced with black patch (no information) in order to isolate features relevant to first image. As a result of feature maps 330a corresponding to subject in first image is produced. The feature maps 330a for the mixed image include a dark portion indicating the location of the corresponding portion of the second image. The GAP is performed on feature maps 330a in order to determine feature vectors for the mixed image.

In second image track, the feature maps 310 are combined with inverted masked portion information 320b. The dark portion of the inverted masked portion information 320b indicates the portion of the feature maps 310 to be replaced with a black area. The masked portion information 320b has an inverse relationship with the masked portion information 320a. That is, the bright portion of the masked portion information 320a corresponds to the dark portion of the masked portion information 320b; and the dark portion of the masked portion information 320a corresponds to the bright portion of the masked portion information 320b. As a result of feature maps 330b for the inverted mixed image are produced. The feature maps 330b isolating features relevant to second image include a dark portion indicating the location of the corresponding portion of the first image. The GAP is performed on feature maps 330b in order to determine feature vectors for the second image.

By using the process 300, an image recognition model is trained faster and with a higher degree of accuracy in comparison with other approaches which do not include masked GAP. The use of the masked GAP helps to force the image recognition model consider all relevant features in images during the training phase resulting in better performance of the image recognition model during the testing phase.

FIGS. 4A-4F are views of images and masks 400A-400E in accordance with some example embodiments. The masks 400A-400E are examples of mask information that is usable for the method 100, the process 300 and by the image recognition system 200. The masks 400A-400E are merely examples and additional modifications or combinations of features of the masks 400A-400E are possible. Some of the following description made with respect to two images. However, one of ordinary skill in the art would understand that more than two images are usable for a method or system implementing masked GAP.

The mask 400A includes masked portion information 410 including a single masked portion 420. The masked portion information 410 includes a size and a location of the masked portion 420. The mask 400A includes the masked portion 420 in a lower right region. In some example embodiments, the masked portion 420 is in a different location of the mask 400A. The masked portion 420 has a rectangular shape.

The mask 400B is similar to the mask 400A. In contrast to the mask 400A, the mask 400B includes a masked portion 420′. The masked portion 420′ is above and to the left of the masked portion 420. The masked portion 420′ has a rectangular shape. In some example embodiments, the location of the masked portion 420′ is in a different location. A size of the masked portion 420 is a same size as the masked portion 420′; A shape of the masked portion 420 is a same shape as the masked portion 420′. In sonic example embodiments, a corresponding portion of a second image is positioned in both the masked portion 420 and the masked portion 420′. In sonic example embodiments, a corresponding portion of the second image is positioned in the masked portion 420; and a corresponding portion of a third image is positioned in the masked portion 420′.

The mask 400C is similar to the mask 400A. In contrast to the mask 400A, the mask 400C includes a masked portion 420″. The masked portion 420″ has a triangular shape. The masked portion 420″ is above and to the left of the masked portion 420. In some example embodiments, the location of the masked portion 420″ is in a different location. A size of the masked portion 420 is different from a size of the masked portion 420″. A shape of the masked portion 420 is different from a shape of the masked portion 420″. In some example embodiments, a corresponding portion of a second image is positioned in both the masked portion 420 and the masked portion 420″. in some example embodiments, a corresponding portion of the second image is positioned in the masked portion 420; and a corresponding portion of a third image is positioned in the masked portion 420″.

The mask 400D is similar to the mask 400A. In contrast to the mask 400A, the mask 400D includes a masked portion 420*. The masked portion 420* has a rectangular shape. The masked portion 420* is above and to the left of the masked portion 420. In some example embodiments, the location of the masked portion 420* is in a different location. A size of the masked portion 420 is different from a size of the masked portion 420*. A shape of the masked portion 420 is the same as a shape of the masked portion 420*. In some example embodiments, a corresponding portion of a second image is positioned in both the masked portion 420 and the masked portion 420*. In some example embodiments, a corresponding portion of the second image is positioned in the masked portion 420; and a corresponding portion of a third image is positioned in the masked portion 420*.

The mask 400E is similar to the mask 400A. In contrast to the mask 400A, the mask 400E includes a masked portion 420″ and a masked portion 420A. The masked portion 420A has a circular shape. The masked portion 420″ is above and to the left of the masked portion 420. In sonic example embodiments, the location of the masked portion 420″ is in a different location. The masked portion 420A is above and to the right of the masked portion 420″. In some example embodiments, the location of the masked portion 420″ is in a different location. A size of the masked portion 42.0 is different from a size of both the masked portion 420″ and the masked portion 420″. In some example embodiments, the size of the masked portion 420″ is different from the size of the masked portion 420A. In some example embodiments, the size of the masked portion 420″ is the same as the size of the masked portion 420″. A shape of the masked portion 420 is different from both a shape of the masked portion 420″ and a shape of the masked portion 420\hat{ }. In some example embodiments, a corresponding portion of a second image is positioned in all of the masked portion 420, the masked portion 420″ and the masked portion 420\hat{ }. In some example embodiments, a corresponding portion of the second image is positioned in at least one of the masked portion 420, the masked portion 420″ and the masked portion 420\hat{ }; and a corresponding portion of a third image is positioned in another of the masked portion 420, the masked portion 420″ and the masked portion 420\hat{ }. In some example embodiments, a corresponding portion of the second image is positioned in one of the masked portion 420, the masked portion 420″ and the masked portion 420\hat{ }; a corresponding portion of a third image is positioned in another of the masked portion 420, the masked portion 420″ and the masked portion 420″; and a corresponding portion of a fourth image is positioned in still another of the masked portion 420, the masked portion 420″, and the masked portion 420\hat{ }.

The mask 400F is similar to the mask 400A. In contrast to the mask 400A, the mask 400F includes a masked portion 420a. The masked portion 420a has a free form shape. The masked portion 420a is in a lower right portion of the mask 400F. In some example embodiments, the location of the masked portion 420a is in a different location. A corresponding portion of a second image is positioned in the masked portion 420a.

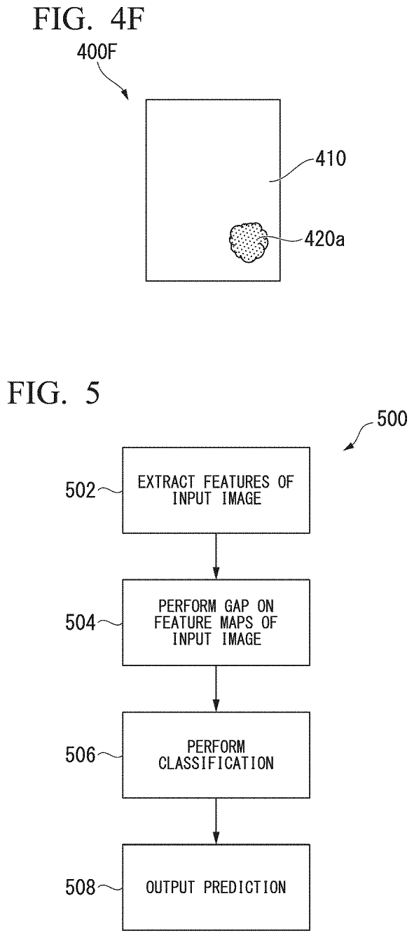

FIG. 5 is a flowchart of a method 500 of testing an image recognition model in accordance with some example embodiments. In some example embodiments, the image recognition model is a trained image recognition model trained using method 100 and/or image recognition system 200.

In operation 502, features of an input image are extracted. In some example embodiments, the features of the input image are extracted in a similar manner as in the operation 106 of the method 100. Extracting the features from includes generating of feature maps for the input image. In some example embodiments where the image recognition model is a CNN, a filter or kernel is used to generate the feature maps. The feature map is formed by convolving the filter with the input image at different locations in the input image to generate a feature map for each location. In some example embodiments, the input image is received from the user. In some example embodiments, the input image is received from an external device.

In operation 504, GAP is performed on the feature maps of the input image. The GAP in a testing phase is not a masked GAP. The masked GAP is utilized in a training phase for producing a trained image recognition model. The GAP generates a feature vector for each feature map of the input image by totaling the elements within the feature map and dividing the total by the number of elements in the feature map.

In operation 506, a classification is performed using the feature vector from the GAP. In some example embodiments, the classification is similar to the classification performed in the operation 112 of the method 100. The classification for the input image is generated based on the feature vectors. In some example embodiments, the classification is generated using a fully connected layer. By using a fully connected. layer, the image recognition model exhibits increased accuracy in comparison with other approaches. The class score for kth class is determined based by taking a dot product of feature vector and weight vector w_k (followed by adding a bias b_k. A highest class with highest score is determined to be the class of the input image.

In operation 508, a prediction is output based on the classification. In sonic example embodiments, the prediction is displayed to the user. In some example embodiments, the classification is output to an external device. In some example embodiments, the user is able to request re-training of the image recognition model in response to receiving an incorrect prediction output.

The method 500 uses an image recognition model trained using masked GAP. As a result, localization accuracy of the method 500 is increased in comparison to method that use image recognition models trained using other approaches. In some example embodiments, the method 500 includes additional operations. For example, in some example embodiments, the method further includes outputting both the prediction and an alternative prediction of the second highest scoring class.

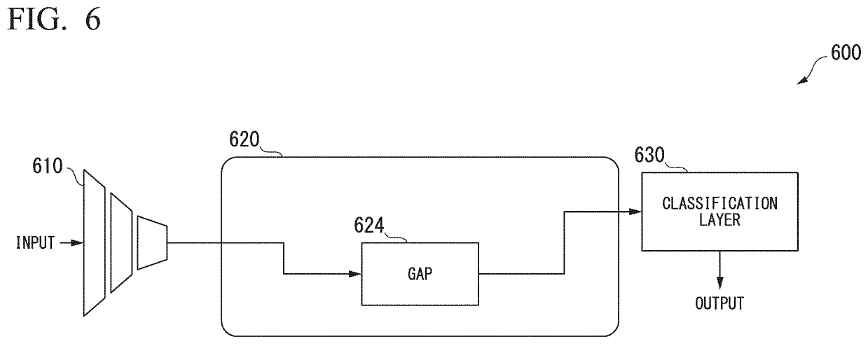

FIG. 6 is a diagram of an image recognition system 600 in accordance with some example embodiments. In some example embodiments, the image recognition system 600 is used for implementing method 500. In some example embodiments, the image recognition system 600 is used for implementing other testing methods.

The image recognition system 600 includes a backbone network 610 for receiving an input image (single image with no mixing applied). The backbone network 610 generates feature maps based on the received input image. In some example embodiments, the backbone network 610 generates the feature maps using operation 502. of the method 500. In some example embodiments, the backbone network 610 generates the feature maps using another method.

The image recognition system 600 further includes a pooling block 620. The pooling block 62( )is configured to perform a GAP process 624 on the feature maps generated by the backbone network 610. In some example embodiments, the pooling block 620 is configured to implement the operation 504 of the method 500. In some example embodiments, the pooling block 620 is configured to perform the GAP process 624 using another technique. The pooling block 620 is configured to output feature vectors based on the received feature maps.

The image recognition system 600 includes a classification layer 630 for generating class scores. The classification layer is configured to receive feature vector from the pooling block 620. The classification layer 630 includes a fully connected layer for predicting an outcome based on the received features vector. The class is determined based on a weight and a bias for a connection between each of the feature vector and the class. A class having a highest score is determined to be the class of the corresponding input image. In some example embodiments, the classification layer 630 executes the operation 506 of the method 500.

In some example embodiments, the image recognition system 600 includes a memory for storing instructions and at least one processor for executing the instructions. The at least one processor is configured to execute the instructions for implementing the backbone network 610, the pooling block 620, and the classification layer 630. In some example embodiments, a structure of the image recognition system 600 is a same structure as the image recognition system 200. That is, the performance of the image recognition system 200 is based on executing a first set of instructions and the performance of the image recognition system 600 is based on executing a second set of instructions. The image recognition system 600 uses an image recognition model trained using masked GAP. As a result, accuracy of the image recognition system 600 is increased in comparison to systems that use image recognition models trained using other approaches.

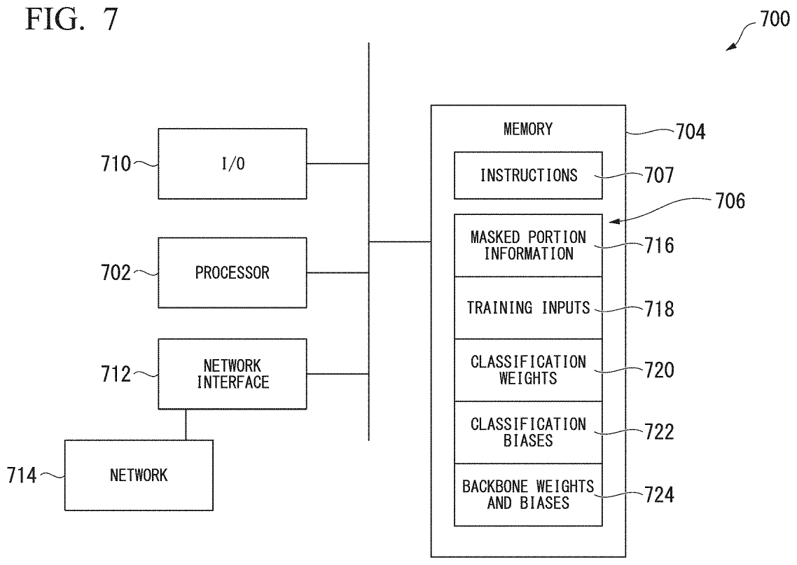

FIG. 7 is a diagram of a system 700 for implementing an image recognition method in accordance with some example embodiments. In some example embodiments, system 700 is usable as the image recognition system 200 or the image recognition system 600. System 700 includes a hardware processor 702 and a non-transitory, computer readable storage medium 704 encoded with, i.e., storing, the computer program code 706, i.e., a set of executable instructions. Computer readable storage medium 704 is also encoded with instructions 707 for interfacing with manufacturing machines for producing the memory array. The processor 702 is electrically coupled to the computer readable storage medium 704 via a bus 708. The processor 702 is also electrically coupled to an 110 interface 710 by bus 708. A network interface 712 is also electrically connected to the processor 702 via bus 708. Network interface 712 is connected to a network 714, so that processor 702 and computer readable storage medium 704 are capable of connecting to external elements via network 714.

The processor 702 is configured to execute the computer program code 706 encoded in the computer readable storage medium 704 in order to cause system 700 to be usable for performing a portion or all of the operations as described in method 100, process 300 or method 500. In some example embodiments, the processor 702 is a central processing unit (CPU), a multi-processor, a distributed processing system, an application specific integrated circuit (ASTC), and/or a suitable processing unit.

In some example embodiments, the computer readable storage medium 704 is an electronic, magnetic, optical, electromagnetic, infrared, and/or a semiconductor system (or apparatus or device). For example, the computer readable storage medium 704 includes a semiconductor or solid-state memory, a magnetic tape, a removable computer diskette, a random access memory (RAM), a read-only memory (ROM), a rigid magnetic disk, and/or an optical disk. In some example embodiments using optical disks, the computer readable storage medium 704 includes a compact disk-read only memory (CD-ROM), a compact disk-read/write (CD-R/W), and/or a digital video disc (DVD).

In some example embodiments, the storage medium 704 stores the computer program code 706 configured to cause system 700 to perform method 100, process 300 or method 500. In some example embodiments, the storage medium 704 also stores information needed for performing a method 100, process 300 or method 500 as well as information generated during performing the method 100, process 300 or method 500, such as a masked portion information parameter 716, a training inputs parameter 718, a classification weights parameter 720, a classification biases parameter 722, a backbone weights and biases parameter 724 and/or a set of executable instructions to perform the operation of method 100, process 300 or method 500.

In some example embodiments, the storage medium 704 stores instructions 707 for interfacing with external devices. The instructions 707 enable processor 702 to generate instructions readable by the external devices to effectively implement the method 100, the process 300 or the method 500.

System 700 includes I/O interface 710. I/O interface 710 is coupled to external circuitry. In some example embodiments, I/O interface 710 includes a keyboard, keypad, mouse, trackball, trackpad, and/or cursor direction keys for communicating information and commands to processor 702.

System 700 also includes network interface 712 coupled to the processor 702. Network interface 712 allows system 700 to communicate with network 714, to which one or more other computer systems are connected. Network interface 712 includes wireless network interfaces such as BLUETOOTH, WIMAX, CPRS, or WCDMA; or wired network interface such as ETRERNET, USB, or IEEE-1394. In some example embodiments, method 100, process 300 or method 500 is implemented in two or more systems 700, and information such as masked portion formation, training inputs, classification weights and classification biases are exchanged between different systems 700 via network 714.

An aspect of this description relates to a method of training an image recognition model. The method includes masking a first region of a first image with a first portion of a second image to define a mixed image, wherein the first image is different from the second image, and a location of the first region in the first image corresponds to a location of the first portion in the second image. The method further includes performing masked global average pooling (GAP) on both the mixed image. The method further includes generating a first classification scores for the first image and a second classification score for the second image based on the masked GAP of the mixed image. In some example embodiments, the method further includes determining a first loss for the first image based on the first classification score; and determining a second loss for the second image based on the second classification score. In some example embodiments, the method further includes modifying a classification layer based on the first loss and the second loss, wherein the classification layer is used to generate the first classification score and the second classification score. In some example embodiments, the method further includes determining whether training of the image recognition model is complete based on the first loss and the second loss. In some example embodiments, the method further includes outputting the image recognition model in response to a determination that the training of the image recognition model is complete. In some example embodiments, the method further includes generating a first set of feature maps based on the mixed image. In some example embodiments, performing the masked GAP on the mixed image includes converting the first set of feature maps into feature vector. In some example embodiments, the method further includes performing feature scaling on the feature vector. In some example embodiments, generating the first classification score includes generating the first classification score based on the feature scaling of the feature vector. In some example embodiments, performing the masked GAP on the mixed image includes performing the mask GAP on the mixed image. In some example embodiments, generating the first classification score includes generating the first classification score simultaneously with generating the second classification score.

An aspect of this description relates to an image recognition system. The image recognition system includes a non-transitory computer readable medium configured to store instructions thereon. The image recognition system further includes a processor connected to the non-transitory computer readable medium. The process is configured to execute the instructions for masking a first region of a first image with a first portion of a second image to define a mixed image, wherein the first image is different from the second image, and a location of the first region in the first image corresponds to a location of the first portion in the second image. The processor is further configured to execute the instructions for performing masked global average pooling (GAP) on both the mixed image. The processor is further configured to execute the instructions for generating a first classification score for the first image and a second classification score for the second image on the masked GAP of the mixed image. In some example embodiments, the processor is further configured to execute the instructions for determining a first loss for the first image based on the first classification score; and determining a second loss for the second image based on the second classification score. In some example embodiments, the processor is further configured to execute the instructions for modifying a classification layer based on the first loss and the second loss, wherein the classification layer is used to generate the first classification score and the second classification score. In some example embodiments, the processor is further configured to execute the instructions for instructing the non-transitory computer readable medium to store eights and biases of the classification layer and backbone network in response to a determination that training of an image recognition model is complete. In some example embodiments, the processor is further configured to execute the instructions for: receiving an input image; extracting features of the input image to define a set of feature maps; performing GAP on the set of feature maps to generate feature vectors; generating an input classification scores based on the feature vectors; and outputting a prediction based on the input classification scores.

An aspect of this description relates to a non-transitory computer readable medium configured to store instructions thereon, which when executed by a processor cause the processor to mask a first region of a first image with a first portion of a second image to define a mixed image, wherein the first image is different from the second image, and a location of the first region in the first image corresponds to a location of the first portion in the second image. The instructions further cause the processor to mask a second region of the second image with a second portion of the first image to define an inverted mixed image, wherein a location of the second region in the second image corresponds to a location of the second portion in the first image. The instructions further cause the processor to perform masked global average pooling (GAP) on both the mixed image and the inverted mixed image. The instructions further cause the processor to generate a first classification score for the first image based on the masked GAP of the mixed image. The instructions thither cause the processor to generate a second classification score for the second image based on the masked GAP of the inverted mixed image. In some example embodiments, the instructions further cause the processor to: determine a first loss for the first image based on the first classification score; and determine a second loss for the second image based on the second classification score. In some example embodiments, the instructions further cause the processor to modify a classification layer based on the first loss and the second loss, wherein the classification layer is used to generate the first classification score and the second classification score. In some example embodiments, the instructions further cause the processor to: instruct the non-transitory computer readable medium to store weights and biases of the classification layer in response to a determination that training of an image recognition model is complete; receive an input image; extract features of the input image to define a set of feature maps; perform GAP on the set of feature maps to generate feature vectors; generate an input classification score based on the feature vectors; and output a prediction based on the input classification score.

The foregoing outlines features of several example embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the example embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

(List of terms and phrases)

TABLE 1

| | | MATHEMATICAL | MORE INFORMATION |
|---|---|---|---|
| | | EQUIVALENT | OF SIZE AND DIMENSION |
| | | (USEFUL WHEN | FOR EACH TERM |
| SERIAL | | REFEREEING TO | (USEFUL FOR PLURAL |
| NUMBER | TERM/PHRASES | TECHNICAL REPORT) | AND SINGULAR) |
| 1 | FIRST IMAGE | x | |
| 2 | SECOND IMAGE | x′ | |
| 3 | MIXED IMAGE | \tilde{x} = M * x + (1 − M) * x′ | |
| 4 | MASK, INVERTED MASK | M, M′ | |
| 5 | SCALE MASK, | m, m′ | |
| | SCALED INVERTED MASK | | |
| 6 | MIXED FEATURE MAPS | \tilde{F} = Backbone (\tilde{x}) | \tilde{F} is a set of stacked |
| | | | 2D feature maps, \tilde{F} is 3D |
| | | | dimensional tensor. |
| 7 | FEATURE MAPS | F = \tilde{F} * m | |
| | CORRESPONDING TO | | |
| | FIRST IMAGE (ONLY | | |
| | REVEALING THOSE AREAS | | |
| | HERE FIRST IMAGE IN | | |
| | MIXED IMAGE IS VISIBLE) | | |
| 8 | FEATURE MAPS | F′ = \tilde{F} * m′ | |
| | CORRESPONDING TO | | |
| | SECOND IMAGE (ONLY | | |
| | REVEALING THOSE AREAS | | |
| | WHERE SECOND IMAGE IN | | |
| | MIXED IMAGE IS VISIBLE) | | |

TABLE 2

| | | | MORE INFORMATION OF |
|---|---|---|---|
| | | | SIZE AND DIMENSION |
| | | MATHEMATICAL EQUIVALENT | FOR EACH TERM |
| SERIAL | | (USEFUL WHEN REFEREEING | (USEFUL FOR PLURAL |
| NUMBER | TERM/PHRASES | TO TECHNICAL REPORT) | AND SINGULAR) |
| 9 | SCALING RATIO | $λ = \frac{num of white pixel in M}{total pixel in M}$ | |
| 10 | SCALED FEATURE VECTOR CORRESPONDING TO FIRST IMAGE | $f = GAP ( F ) * ( \frac{1}{λ} )$ | f is basically a 1D vector; i^{th} element in f represents average of i^{th} feature map in F |
| 11 | SCALED FEATURE VECTOR CORRESPONDING TO SECOND IMAGE | ${f}^{′} = GAP ( {F}^{′} ) * ( \frac{1}{1 - λ} )$ | F′ is basically a 1D vector; i^{th} element in f represents average of i^{th} feature map in F′ |
| 12 | CLASSIFICATION | c = fc(f) | c is basically a 1D |
| | SCORE | | vector with size K; k^{th} |
| | CORRESPONDING | | element in c represents |
| | FOR FIRST IMAGE | | the predicted class |
| | | | scores for k^{th} class |
| 13 | CLASSIFICATION | c′ = fc(f′) | c′ is basically a 1D |
| | SCORE | | vector with size K; k^{th} |
| | CORRESPONDING | | element in c′ represents |
| | FOR SECOND IMAGE | | the predicted class |
| | | | scores for k^{th} class |
| 14 | FIRST | | Isolate the features |
| | IMAGE TRACK | | corresponding to subject |
| | | | in first image |
| 15 | SECOND | | Isolate the features |
| | IMAGE TACK | | corresponding to subject |
| | | | in second image |

The example embodiments described above may also be described entirely or in part by the following supplementary notes, without being limited to the following.

### (Supplementary Note 1)

A method of training an image recognition model, the method comprising: masking a first region of a first image with a first portion of a second image to define a mixed image, wherein the first image is different from the second image, and a location of the first region in the first image corresponds to a location of the first portion in the second image;

performing masked global average pooling (GAP) on both the mixed image; and

generating a first classification score for the first image and a second classification score for the second image based on the masked GAP of the mixed image.

### (Supplementary Note 2)

The method of supplementary note 1, further comprising:

determining a first loss for the first image based on the first classification score; and

determining a second loss for the second image based on the second classification score.

### (Supplementary Note 3)

The method of supplementary note 2, further comprising modifying a classification layer and backbone network based on the first loss and the second loss, wherein the classification layer is used to generate the first classification score and the second classification score.

### (Supplementary Note 4)

The method of supplementary note 2, further comprising determining whether training of the image recognition model is complete based on the first loss and the second loss.

### (Supplementary Note 5)

The method of supplementary note 4, further comprising outputting the image recognition model in response to a determination that the training of the image recognition model is complete.

### (Supplementary Note 6)

The method of supplementary note 1, further comprising generating a first set of feature maps based on the mixed image.

### (Supplementary Note 7)

The method of supplementary note 6, wherein performing the masked GAP on the mixed image comprises converting the first set of feature maps into feature vector.

### (Supplementary Note 8)

The method of supplementary note 7, further comprising performing feature scaling on the feature vectors.

### (Supplementary Note 9)

The method of supplementary note 8, wherein generating the first classification score comprises generating the first classification score based on the feature scaling of the feature vectors.

### (Supplementary Note 10)

The method of supplementary note 1, wherein generating the first classification score comprises generating the first classification score prior to generating the second classification score.

### (Supplementary Note 11)

The method of supplementary note 1, wherein generating the first classification score comprises generating the first classification score simultaneously with generating the second classification score.

### (Supplementary Note 12)

An image recognition system comprising:

a non-transitory computer readable medium configured to store instructions thereon; and

a processor connected to the non-transitory computer readable medium, wherein the process is configured to execute the instructions for:

masking a first region of a first image with a first portion of a second image to define a mixed image, wherein the first image is different from the second image, and a location of the first region in the first image corresponds to a location of the first portion in the second image;

performing masked global average pooling (GAP) on both the mixed image; and

generating a first classification score for the first image and a second classification score for the second image based on the masked GAP of the mixed image.

### (Supplementary Note 13)

The image recognition system of supplementary note 12, wherein the processor is further configured to execute the instructions for:

determining a first loss for the first image based on the first classification score; and

determining a second loss for the second image based on the second classification score.

### (Supplementary Note 14)

The image recognition system of supplementary note 13, wherein the processor is further configured to execute the instructions for modifying a classification layer based on the first loss and the second loss, wherein the classification layer is used to generate the first classification score and the second classification score.

### (Supplementary Note 15)

The image recognition system of supplementary note 14, wherein the processor is further configured to execute the instructions for instructing the non-transitory computer readable medium to store weights and biases of the classification layer and backbone network in response to a determination that training of an image recognition model is complete;

### (Supplementary Note 16)

The image recognition system of supplementary note 15, wherein the processor is further configured to execute the instructions for: receiving an input image;

extracting features of the input image to define a set of feature maps; performing GAP on the set of feature maps to generate vector;

generating an input classification score based on the feature vectors; and outputting a prediction based on the input classification score.

### (Supplementary Note 17)

A program comprising instructions, which when executed by a processor cause the processor to:

mask a first region of a first image with a first portion of a second image to define a mixed image, wherein the first image is different from the second image, and a location of the first region in the first image corresponds to a location of the first portion in the second image;

perform masked global average pooling (GAP) on both the mixed image and the inverted mixed image; and

generate a first classification score for the first image and a second classification score for the second image based on the masked GAP of the mixed image.

### (Supplementary Note 18)

The program of supplementary note 17, wherein the instructions further cause the processor to:

determine a first loss for the first image based on the first classification score; and determine a second loss for the second image based on the second classification score.

### (Supplementary Note 19)

The program of supplementary note 18, wherein the instructions further cause the processor to modify a classification layer based on the first loss and the second loss, wherein the classification layer is used to generate the first classification score and the second classification score.

### (Supplementary Note 20)

The program of supplementary note 17, wherein the instructions further cause the processor to:

instruct the non-transitory computer readable medium to store weights and biases of the classification layer and backbone network in response to a determination that training of an image recognition model is complete;

receive an input image;

extract features of the input image to define a set of feature maps;

perform GAP on the set of feature maps to generate feature vectors;

generate an input classification score based on the feature vectors; and

output a prediction based on the input classification score.

### (Supplementary Note 21)

A non-transitory computer readable medium configured to store instructions thereon, which when executed by a processor cause the processor to:

mask a first region of a first image with a first portion of a second image to define a mixed image, wherein the first image is different from the second image, and a location of the first region in the first image corresponds to a location of the first portion in the second image;

perform masked global average pooling (GAP) on both the mixed image and the inverted mixed image; and

generate a first classification score for the first image and a second classification score for the second image based on the masked GAP of the mixed image;

This application is based upon and claims the benefit of priority from U.S. provisional patent application No. 63/038181, filed Jun. 12, 2020, the disclosure of which is incorporated herein in its entirety.

### INDUSTRIAL APPLICABILITY

The present invention may be applied to a weakly supervised object localization method and a system for implementing the same.

1. A method of training an image recognition model, the method comprising:
masking a first region of a first image with a first portion of a second image to define a mixed image, wherein the first image is different from the second image, and a location of the first region in the first image corresponds to a location of the first portion in the second image;
performing masked global average pooling (GAP) on the mixed image; and
generating a first classification score for the first image and a second classification score for the second image based on the masked GAP of the mixed image.

2. The method of claim 1, further comprising:
determining a first loss for the first image based on the first classification score; and
determining a second loss for the second image based on the second classification score.

3. The method of claim 2, further comprising modifying a classification layer and backbone network based on the first loss and the second loss, wherein the classification layer is used to generate the first classification score and the second classification score.

4. The method of claim 2, further comprising determining whether training of the image recognition model is complete based on the first loss and the second loss.

5. The method of claim 4, further comprising outputting the image recognition model in response to a determination that the training of the image recognition model is complete.

6. The method of claim 1, further comprising generating a first set of feature maps based on the mixed image.

7. The method of claim 6, wherein performing the masked GAP on the mixed image comprises converting the first set of feature maps into feature vector.

8. The method of claim 7, further comprising performing feature scaling on the feature vectors.

9. The method of claim 8, wherein generating the first classification score comprises generating the first classification score based on the feature scaling of the feature vectors.

10. The method of claim 1, wherein generating the first classification score comprises generating the first classification score prior to generating the second classification score.

11. The method of claim 1, wherein generating the first classification score comprises generating the first classification score simultaneously with generating the second classification score.

12. An image recognition system comprising:
a non-transitory computer readable medium configured to store instructions thereon; and
a processor connected to the non-transitory computer readable medium, wherein the process is configured to execute the instructions for:
masking a first region of a first image with a first portion of a second image to define a mixed image, wherein the first image is different from the second image, and a location of the first region in the first image corresponds to a location of the first portion in the second image;
performing masked global average pooling (GAP) on both on the mixed image; and
generating a first classification score for the first image and a second classification score for the second image based on the masked GAP of the mixed image.

13. The image recognition system of claim 12, wherein the processor is further configured to execute the instructions for:
determining a first loss for the first image based on the first classification score; and
determining a second loss for the second image based on the second classification score.

14. The image recognition system of claim 13, wherein the processor is further configured to execute the instructions for modifying a classification layer based on the first loss and the second loss, wherein the classification layer is used to generate the first classification score and the second classification score.

15. The image recognition system of claim 14, wherein the processor is further configured to execute the instructions for instructing the non-transitory computer readable medium to store weights and biases of the classification layer and backbone network in response to a determination that training of an image recognition model is complete.

16. The image recognition system of claim 15, wherein the processor is further configured to execute the instructions for:
receiving an input image;
extracting features of the input image to define a set of feature maps;
performing GAP on the set of feature maps to generate vector;
generating an input classification score based on the feature vectors; and
outputting a prediction based on the input classification score.

17. A non-transitory recording medium that stores instructions, which when executed by a processor cause the processor to:
mask a first region of a first image with a first portion of a second image to define a mixed image, wherein the first image is different from the second image, and a location of the first region in the first image corresponds to a location of the first portion in the second image;
perform masked global average pooling (GAP) on the mixed image; and
generate a first classification score for the first image and a second classification score for the second image based on the masked GAP of the mixed image.

18. The recording medium of claim 17, wherein the instructions further cause the processor to:
determine a first loss for the first image based on the first classification score; and
determine a second loss for the second image based on the second classification score.

19. The recording medium of claim 18, wherein the instructions further cause the processor to modify a classification layer based on the first loss and the second loss, wherein the classification layer is used to generate the first classification score and the second classification score.

20. The recording medium of claim 17, wherein the instructions further cause the processor to:
instruct the non-transitory computer readable medium to store weights and biases of the classification layer and backbone network in response to a determination that training of an image recognition model is complete;
receive an input image;
extract features of the input image to define a set of feature maps;
perform GAP on the set of feature maps to generate feature vectors;
generate an input classification score based on the feature vectors; and
output a prediction based on the input classification score.
